(19) United States
(12) Patent Application Publication
(10) Pub. No.: US 2003/0232167 A1
(43) Pub. Date: Dec. 18, 2003

(54) Arrangement and also a method for applyig a label to a data carrier such that it is centralised thereon

(76) Inventors: Ralf Wimmershoff, Dusseldorf (DE); Achim Becker, Dusseldorf (DE)

Correspondence Address: Anderson Kill & Olick, P.C., 1251 Avenue of the Americas, New York, NY, 10020-1182, US

(21) Appl. No.: 10/330,753

(22) Filed: Dec. 26, 2002

(30) Foreign Application Priority Data
Jun. 18, 2002 (DE) DE 102 27 230.1

(51) Int. Cl. B32B 31/00

(52) U.S. Cl. 428/42.1; 156/234; 156/256

(57) ABSTRACT

An arrangement (11; 12) comprises a carrier layer and also a label layer which is arranged thereon in detachable manner and is provided with a self-adhesive layer on the lower face thereof. A peripheral impression (15; 23), which defines the contour of the label (110, 120) is provided on the label layer. Two isolating impressions (16, 17; 24, 25) are arranged on the label layer and on the carrier layer, these impressions extending respectively from an edge (30) of the label layer to the peripheral impression (15; 23), and there is also at least one alignment impression (18, 19; 26, 27) which extends from an edge (13) of the label layer at least partially towards the peripheral impression (15; 23). There is provided on the carrier layer a segmenting impression (21; 29) which extends at least between the isolating impressions (16, 17; 24, 25).

The invention relates to an arrangement and also to a method for applying a label to a data carrier such that it is centralised thereon.

In practice, data carriers and especially CD-ROMs, rewritable CDs or DVD are frequently provided with labels i.e. labels are adhered thereto. These labels may be blank or carry an inscription and may, in particular, be printed in colour.

When applying such labels to a data carrier, the problem frequently arises that the labels can only be centred on the data carriers with difficulty. If a label is not applied centrally to a data carrier, then errors can occur when writing to the data carrier and/or when accessing the data stored on the data carrier. Moreover, if a label is not applied centrally to a data carrier, then the appearance of such a data carrier and also the saleability of such labels is adversely affected.

It is conceivable for labels for CDs and DVDs to be made available on standardised sheets of paper. Hereby, these sheets of paper comprise a carrier layer and also a label layer which is arranged thereon in detachable manner and is provided with a self-adhesive layer on the lower face thereof. Impressions, which are made through the carrier layer and also through the label layer, are provided at the edges of the narrow sides of the rectangular sheet. These impressions are got by punching holes into the sheet of paper. The CD or DVD which is to have a label adhered thereto is then fixed in a centring aid made of plastic that is supplied therewith. Thereafter, the sheet of paper is placed on this centring aid in such a manner that centring pins formed on the centring aid will match the holes in the sheet of paper. A circular ring is stamped on the carrier film on the lower face of the sheet of paper at the side of the sheet of paper opposed to the centring pins. This circular ring of the carrier film is removed from the sheet of paper and the adhesive coated lower face of the sheet of paper is pressed against the CD or DVD and stuck thereto. When fixed in this manner, the label sheet can be pulled away from the centring pins, the remaining carrier foils peeled off to the side of the stamped holes and the label can then be stuck to the CD by the application of pressure. A disadvantage of this arrangement is that an additional centring aid is required. Furthermore, it is unfavourable that two additional procedural steps have to be carried out, namely, the insertion of the CD or the DVD into the centring aid and the removal of the CD or the DVD from the centring aid after the label has been applied.

A label for application to a CD is depicted in U.S. Pat. No. 5,715,934 which comprises a label adherence portion and a detachable centring portion which is firmly attached thereto. Hereby, the centring portion is formed in such a manner that the label exactly matches the CD if the outer edge of the centring portion rests on the inner contour of a portable case used for storing the CD. The label depicted in U.S. Pat. No. 5,715,934 incorporating the label adherence portion and the centring portion is not in a standard format such as a DIN A4 format, but takes the form of something which is bounded to one side by a circular edge. It is a disadvantage of such a label that it can only be printed upon with difficulty by conventional printers. Furthermore, it is disadvantageous that the entire surface of the label is adhered to the surface of the CD in one step. Namely, the label may be stuck on in a position deviating from the centralised position.

The object of the invention is to produce an economical arrangement with which labels can be easily and reliably applied to a data carrier such that they are centralised. Furthermore, another object of the invention is to provide a method with which labels can be applied quickly and precisely to a data carrier using such an arrangement.

This object is achieved by the subject matters of the independent Claims. Advantageous developments of the invention are specified in the appendant claims.

In accordance with the invention, the arrangement for applying a label to a data carrier such that it is centralised thereon is divided into a label layer and a carrier layer. The label layer is arranged on the carrier layer in detachable manner in that a self-adhesive layer is provided on the lower face of the label layer.

A preferably continuous peripheral impression, which defines the contour of the label, is provided on the label layer. At least two mutually parallel isolating impressions are provided on the label layer and also on the carrier layer. These impressions extend respectively from one edge of the label layer to the peripheral impression and may be continuous or discontinuous. Moreover, at least one continuous or discontinuous alignment impression, which extends from an edge of the label layer at least partially towards the peripheral impression, is provided on both the carrier layer and the label layer.

This alignment impression serves exclusively for aligning the arrangement in accordance with the invention and may be of different lengths. Hereby, the length of the alignment impression may be such that it will enable alignment to be made with an object, such as a data carrier case, with the help of an edge ensuing from the severance of the alignment impression. For example, such an alignment impression may be in the form of a straight line and extend for a short distance from an edge of the label layer.

Furthermore, at least one segmenting impression, which extends between the isolating impressions and may likewise be continuous or discontinuous, is provided on the carrier layer. This segmenting impression could also be formed over the entire width of the carrier layer, this being very advantageous from a production point of view.

One of the fundamental concepts of the invention consists in the provision of a label for a data carrier and also a positioning aid for centralised application of the label on this data carrier in a single arrangement.

In accordance with a further fundamental concept of the invention, recourse is made to a data carrier case, in which the data carrier is laid, for applying the label centrally to the data carrier. Preferably, the data carrier is a CD or a DVD and the data carrier case is a conventional CD box which is also referred to as a jewel case.

In the arrangement for applying a label to a data carrier in centralised manner in accordance with the invention, it is advantageous that no additional positioning aid or centring aid is required. Furthermore, in the case of the arrangement in accordance with the invention, it is advantageous that it is constructed in an easily understandable and self-explanatory manner. It is easily possible to place labels in a centralised position on a data carrier in a reliable manner. For the purposes of aligning the arrangement in accordance with the invention with respect to the data carrier case containing the data carrier, one or more alignment impressions are advantageously used.

It is advantageous if the isolating impressions and the alignment impressions are each in the form of a number of impressions comprising retention points. Here, retention points should be understood as being very short areas along the impressions which are not stamped out in the carrier layer and in the label layer. These retention points are adapted to be easily severed and simultaneously increase the stability of the arrangement in accordance with the invention. It is particularly advantageous if two to five retention points are provided for an isolating impression and if one to two retention points are provided for an alignment impression.

In accordance with a first embodiment of the invention, the alignment impression or the alignment impressions extend between an edge of the label layer and the peripheral impression. This thereby enables the arrangement in accordance with the invention to be aligned with a data carrier case in a particularly advantageous manner.

In accordance with a further embodiment of the invention, the arrangement in accordance with the invention additionally comprises at least one separating impression which may be continuous or interrupted at regular intervals and is formed in the carrier layer and also in the label layer. Such a separating impression extends from an edge of the label layer to the opposite edge of the label layer. Severing such a separating impression is easily possible. In the case of this embodiment, the alignment impression or the alignment impressions may likewise be of very short length, but the lengths are such as to enable alignment to be made with an object, such as a data carrier case, with the help of an edge ensuing from the severance of the alignment impression.

Due to the provision of such separating impressions, the edges of the arrangement in accordance with the invention, especially the edges required for positioning the arrangement in accordance with the invention with respect to the edge of a data carrier case, can be protected from damage in an effective manner. More precise positioning of the label on the data carrier can be ensured by virtue of the provision of such separating impressions.

In the case of the embodiment of the arrangement in accordance with the invention incorporating a separating impression, the alignment impression or the alignment impressions each extend between an edge of the separating impression and the peripheral impression. This thereby enables particularly advantageous positioning of the arrangement in accordance with the invention in relation to the data carrier.

In a particularly advantageous development of the invention, there are provided two alignment impressions which respectively extend in parallel in the carrier layer and in the label layer. The straight edge included by these alignment impressions can thereby be used in a particularly advantageous manner for positioning the arrangement with respect to the data carrier case. Hereby, the alignment impressions respectively extend at least partially towards the peripheral impression from the same edge of the arrangement in accordance with the invention. Due to the provision of two alignment impressions, which are ideally provided on the same edge or on the same separating impression, it becomes possible to position the arrangement in accordance with the invention with high precision and also to achieve user-friendly manipulation thereof.

According to a further advantageous development of the invention, the isolating impressions respectively extend to the peripheral impression from opposite edges of the label layer which include the edge of the alignment impressions. Hereby, these isolating impressions are advantageously inclined so that they touch the peripheral impression at a low angle. This thereby prevents the carrier layer and the label layer from being torn when severing the impressions.

The invention also relates to an arrangement including a label layer and a carrier layer for the application of a label to a data carrier in centralised manner which comprises a label formed in the label layer and at least one alignment flap formed in the label layer and in the carrier layer. Hereby, the alignment flap comprises a label layer alignment section which adjoins the label and a carrier layer alignment section arranged therebelow. The carrier layer alignment section has approximately the same shape as the label layer alignment section outside the label, and has an additional overlapping area which extends for at least a short distance below the label.

According to a further basic concept of the invention, the label layer alignment section and the carrier layer alignment section comprise at least one common alignment edge which is especially provided for the purposes of aligning it with a data carrier case. Due to the overlapping area of the carrier layer alignment section, it is ensured that the alignment flap or the alignment flaps will remain firmly connected to the label even when a large part of the label has been released from the carrier layer. This thereby results in simple alignment of the label with reference to a data carrier case and precise positioning of the label when it is applied to the upper face of this data carrier.

According to a further advantageous development of the invention, the label-layer alignment-section and the carrier-layer alignment-section have two common alignment edges which, in particular, adjoin one another. Hereby, at least partially straight alignment edges can be provided therebetween, advantageously at a right angle. The result of this is that the arrangement in accordance with the invention can be aligned with respect to one or more bearing and/or positioning edges of the data carrier case in a particularly advantageous manner.

According to a further embodiment of the invention, the label layer has a peripheral impression which defines the contour of the label and also a label-layer alignment-section impression for each alignment flap, whilst the carrier layer comprises a carrier-layer alignment-section impression for each alignment flap. The label-layer alignment-section impression is seated on a section of the peripheral impression and extends outside the peripheral impression in that it surrounds the alignment section. The carrier-layer alignment-section impression extends outside the peripheral impression in parallel with the label-layer alignment-section impression and surrounds an overlapping area within the peripheral impression. Due to the provision of these impressions, which may be discontinuous or perforated but could also be discontinuous, there is thus provided one possible, easily implementable method of producing an arrangement in accordance with the invention for applying a label to a data carrier such that it is centralised thereon.

It is particularly advantageous if the carrier-layer alignment-section impression outside the peripheral impression is located at a small distance of approximately 1 mm relative to the label-layer alignment-section impression. The lower face of the label layer applicator arrangement may be stuck on in the narrow region between the carrier-layer alignment-section impression and the label-layer alignment-section impression during the positioning process on the interchangeable data carrier case, thereby enabling the positioning of the label on the data carrier to be effected in a user-friendly and particularly precise manner. This narrow region of the label layer applicator arrangement can be easily removed after the label has been placed on the interchangeable data carrier.

In addition to the alignment flaps, there may be provided a guide flap which is divided into a label layer guide section adjoining the label and into a carrier layer guide section. The label layer guide section and the carrier layer guide section may have substantially the same shape outside the label, but the carrier layer guide section extends for at least a short distance into the surface below the label and thus incorporates an overlapping area. Due to the provision of such a guide flap, the label can be released from the carrier layer in a particularly user-friendly manner. Touching the self-adhesive layer on the lower face of the label, which could adversely affect the cohesion or boundary face adhesion of the label to the data carrier, is thereby prevented.

It is particularly advantageous that the label is adapted to be detached from the carrier layer if the guide flap is arranged on the side or sides of the peripheral impression remote from the alignment flap or flaps.

According to a further embodiment of the invention, the label layer comprises a label-layer guide-section impression surrounding the guide section and the carrier layer comprises a carrier-layer guide-section impression. The label-layer guide-section impression is thereby seated on a section of the peripheral impression and extends outside the peripheral impression. The carrier-layer guide-section impression extends outside the peripheral impression in parallel with the label layer guide impression and surrounds an overlapping area within the peripheral impression. The provision of the guide flaps by means of such impressions is easy to implement from a production point of view. The severing of such impressions is user-friendly and can be done with great precision.

It is particularly advantageous if the alignment section impression or the alignment section impressions and the guide section impression are in the form of impressions which comprise a number of retention points. They are then particularly easy to sever whilst being stable at the same time.

If the overlapping areas are in the form of an arc of a circle having a very small width of approximately 4 mm, then they can be detached particularly easily from the label after the label has been applied to the interchangeable data carrier. This increases the user-friendliness of the arrangement and is easy to implement from a production point of view.

The label is adapted to be applied to the data carrier particularly precisely and particularly reliably if there are provided two alignment flaps which, in particular, are arranged next to one another and are disposed such that the alignment edges thereof correspond to the length of a bearing edge of a data carrier case.

The arrangement in accordance with the invention can be produced such that the label is in the form of a circle. This is achieved by means of a circular peripheral impression. Hereby, a central cut-out may also be provided in the label in that, in particular, a round cut-out impression is provided in the centre of the label on the label layer. Thus, by virtue of the invention, labels for conventional CDs and DVDs can be made available which can be applied thereto such that they are centralised in a particularly precise and particularly reliable manner.

It is particularly advantageous if the peripheral impression is circular. This represents the most common type of label, especially in the case of CDs or DVDs. A circular shaped label can be produced very easily and to particular advantage by means of a circular peripheral impression.

According to a further embodiment of the invention, a cut-out impression, especially a circular one, can be envisaged which defines a central cut-out in the label. In the case of data carriers in the form of CDs or DVDs for example, such a central cut-out is often necessary. The cut-out impression that makes allowance for this cut-out may be of different diameters and is advantageously formed only on the label layer. Unintentional severing of the cut-out impression is thereby prevented. A portion of the surface of the data carrier of differing size can be covered by the label in dependence on the diameter of the cut-out impression. Such cut-outs can be easily and advantageously implemented with the arrangement in accordance with the invention.

The invention also relates to a self-adhesive printing paper. This self-adhesive printing paper is divided into a label layer which is provided with a self-adhesive layer on the lower face thereof and also into a carrier layer upon which the label layer is arranged in detachable manner. The self-adhesive printing paper thereby comprises regions which incorporate the previously described arrangements. Accordingly, the labels that are to be printed upon are arranged on printing paper of standard format.

In the case of the self-adhesive printing paper in accordance with the invention incorporating regions comprising the previously described arrangements, it is very advantageous if this printing paper can be printed or inscribed using conventional printers, in particular, inkjet printers, laser printers or dot matrix printers. Hereby, this self-adhesive printing paper can be envisaged as being in the form of standard formats such as DIN A4, DIN A5 or DIN A3. It is particularly advantageous if the printing paper is in the DIN A4 format and if it comprises two label applicator devices or arrangements in accordance with the invention. The selection of the area of the particular printing paper that is to be printed upon can thereby be effected, in particular, by appropriate application software. It is thereby ensured that, by virtue of the arrangement in accordance with the invention, labels for data carriers can be printed upon very advantageously.

Furthermore, the invention relates to a method of applying a label to a data carrier inserted into a data carrier case in centralised manner using an arrangement as described hereinabove. Hereby, the data carrier case comprises a seating recess for accommodating a data carrier, at least one positioning edge and also a bearing edge.

In a first step in accordance with the invention, a data carrier is placed in the seating recess. The isolating impressions are then severed. In the next step of the method in accordance with the invention both the segmenting impression formed on the carrier layer and the smaller part of the peripheral impression on the label layer that is arranged between the isolating impressions are severed. Accordingly, the label being applied by the arrangement in accordance with the invention no longer comprises a carrier layer in an area between the segmenting impression and the peripheral impression.

In the next step of the method in accordance with the invention, at least one alignment impression that is formed on both the label layer and on the carrier layer is severed. The arrangement in accordance with the invention including this severed alignment impression is then aligned with the positioning edge of the data carrier case. The straight edge of the arrangement in accordance with the invention bordering the alignment impression is thereby placed in contact with a bearing edge of the data carrier case. The arrangement in accordance with the invention is thereby aligned in such a manner that the lower face of the label layer points towards the upper face of the data carrier.

In the succeeding step, that part of the lower face of the arrangement in accordance with the invention which is arranged between the segmenting impression and the peripheral impression and no longer comprises a carrier layer is adhered to the upper face of the data carrier. Thereafter, the remaining peripheral impression is severed and the part of the carrier layer arranged between the segmenting impression and the remaining part of the peripheral impression is removed. Hereby, it advantageous that this removal process be effected in a direction towards the alignment impression. The lower face of the arrangement in accordance with the invention that has been parted from the carrier layer in this manner is now stuck on the upper face of the data carrier. Hereby, the label layer is pressed onto the upper face of the data carrier, advantageously, commencing from the previously adhered portion towards the alignment impression.

With the help of this method in accordance with the invention, centralised application of a label to a data carrier can easily be executed. For the purposes of positioning the label in relation to the data carrier, merely a data carrier case, preferably a conventional CD box, but no additional positioning means is required. The label is applied to the data carrier such that it is precisely positioned and centred using the method in accordance with the invention.

In the event of two alignment impression being provided on the arrangement in accordance with the invention, then both of these alignment impressions are severed. The alignment of the arrangement in accordance with the invention is effected by aligning the first alignment impression with a first positioning edge and the second alignment impression with a second positioning edge of the data carrier case. The straight edge included by the two alignment impressions on the arrangement in accordance with the invention is thereby placed in contact with a bearing edge of the data carrier case. The lower face of the label layer of the arrangement in accordance with the invention thereby points towards the upper face of the data carrier. Particularly reliable and precise positioning and application of the label to the data carrier is thereby made possible. Advantageously hereby, the spacing between the two alignment impressions corresponds to the spacing between the two positioning edges of the data carrier case.

In a particularly advantageous further development of the invention wherein the arrangement in accordance with the invention comprises a label layer separating impression and also a carrier layer separating impression, the method step in accordance with the invention of severing the label layer separating impression and the carrier layer separating impression is implemented following the insertion of a data carrier into the seating recess. This method step could also be performed at another point in the method in accordance with the invention but should be executed before the step of severing the alignment impression or the alignment impressions. Due to the provision of this method step, it is ensured that the straight edge of the arrangement in accordance with the invention that is located between two alignment impressions or adjoining an alignment impression will be protected from damage. Due to this advantageous further development of the method in accordance with the invention, particularly reliable and particularly precise alignment and positioning of the label on the surface of the data carrier is achieved.

Furthermore, the invention relates to a method of applying a label to a data carrier in centralised manner using an arrangement as described hereinabove which comprises at least one alignment flap having an overlapping area. Initially hereby, a data carrier is inserted into the seating recess and thereafter the alignment section or the alignment sections is or are released from the label layer and the carrier layer, whereby the overlapping area or the overlapping areas on the carrier layer remain connected to the label. The label is then peeled off the carrier layer with the exception of the overlapping area or areas. The alignment edge or the alignment edges are now aligned with at least one positioning edge and/or with a bearing edge of the data carrier case. The lower face of the label layer is thereby directed towards the upper face of the data carrier. The lower face of the label is then stuck to the upper face of the data carrier by pressing the front face of the label onto the data carrier. Thereafter, the alignment flap or the alignment flaps is or are peeled off laterally whereby the overlapping areas will be released from the label. Finally, the lower face of the label layer at this overlapping area or these overlapping areas is adhered to the upper face of the data carrier.

This method in accordance with the invention represents a simple and rapidly executable way of precisely positioning labels on a data carrier wherein merely the case of the data carrier is used for alignment purposes.

In an advantageous further development of this method, an arrangement is considered which additionally comprises a guide flap. Hereby, there is provided the additional step of releasing the guide section from the label layer and from the carrier layer whereby the overlapping area of the guide flap initially remains connected to the label. The label is then peeled off the carrier layer with the exception of the overlapping areas. In particular hereby, the guide flap is gripped and the label is released from the carrier layer in a direction towards the alignment section or the alignment sections. Following the processes of aligning the arrangement and sticking on the label, the alignment flap or the alignment flaps and the guide flap are peeled off laterally and the overlapping areas of the label layer are likewise adhered to the upper face of the data carrier.

Due to the provision of such a guide flap in an arrangement in accordance with the invention, the label can be stuck onto the data carrier in a particularly user-friendly manner whereby touching of the adhesive coated lower face of the label is advantageously prevented.

The method also relates to arrangements in accordance with the invention wherein the alignment flap or the alignment flaps and/or the guide flap are implemented by means of impressions, in particular, by means of label-layer alignment-section impressions, by means of carrier-layer alignment-section impressions, by means of label-layer guide-section impressions and also by means of carrier-layer guide-section impressions. In the presence of such impressions, the alignment flap or the alignment flaps and/or the guide flap are released from the label layer and from the carrier layer at the beginning of the procedure, in that the impressions are severed. Hereby, the label layer and the carrier layer of the alignment flap or the alignment flaps and/or the guide flap initially remain connected to one another.

Release of such impressions is easily effected without auxiliary means, such as scissors for example, thereby simultaneously ensuring that the ensuing edges will be very precise. The contour of the label may also be bounded by a peripheral impression which is preferably continuous. The method step of peeling off the label from the carrier layer is thereby associated with the severance of the peripheral impression.

In the event that a spacing is provided between the label-layer alignment-section impression and the carrier-layer alignment-section impression, then the alignment of the label applicator arrangement can be assisted by temporarily sticking the narrow portion of the lower face of the label applicator arrangement between the label-layer alignment-section impression and the carrier-layer alignment-section impression onto the interchangeable data carrier case. Crooked or non-centralised application of the label is thereby advantageously prevented. The narrow regions can easily be removed from the interchangeable data carrier case after the label has been applied.

Finally a cut-out impression could also be provided in the centre of the label, this thereby defining the contour of a central cutout in the label. In this case, there is provided an additional method step of severing the cut-out impression and removing the portion of the label layer located within the cut-out impression. This is effected in a particularly easy manner in that the cut-out is pressed downwardly or is held on the carrier layer whilst the label is peeled off the carrier layer. Hence, it is possible to easily apply and precisely position CD and/or DVD labels.

The invention is depicted in more detail in the Figures and will be explained with the help of three embodiments.

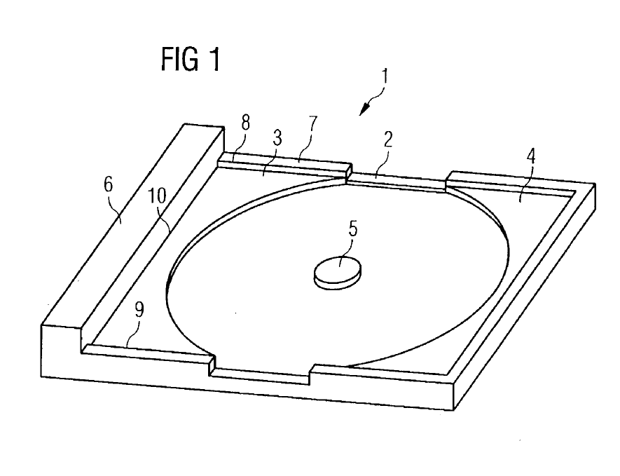

FIG. 1 shows a schematic perspective illustration of an interchangeable data carrier case for accommodating an interchangeable data carrier,

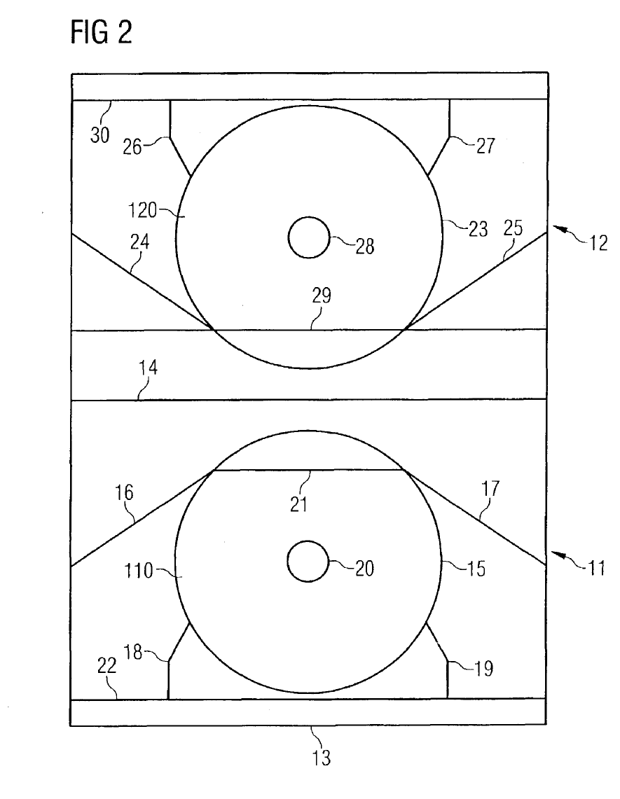

FIG. 2 shows a first DIN A4 sheet incorporating a first label applicator arrangement and a second label applicator arrangement in accordance with a first exemplary embodiment,

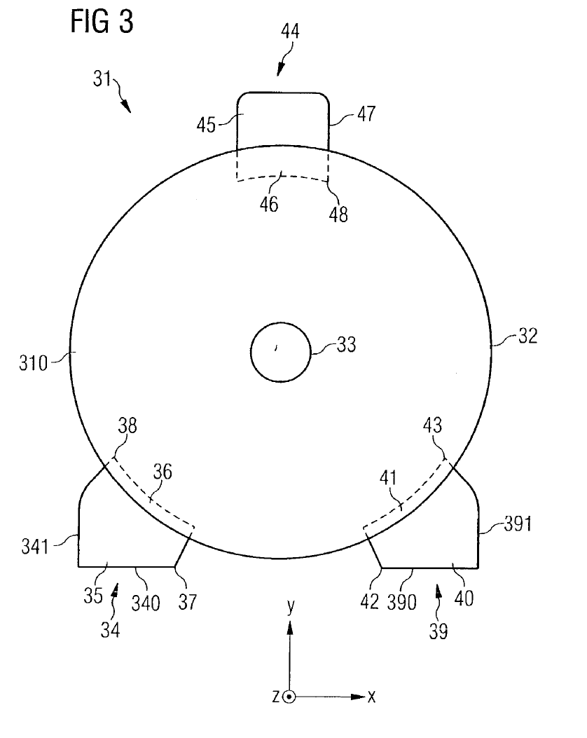

FIG. 3 shows a schematic top view of a third label applicator arrangement in accordance with a second exemplary embodiment,

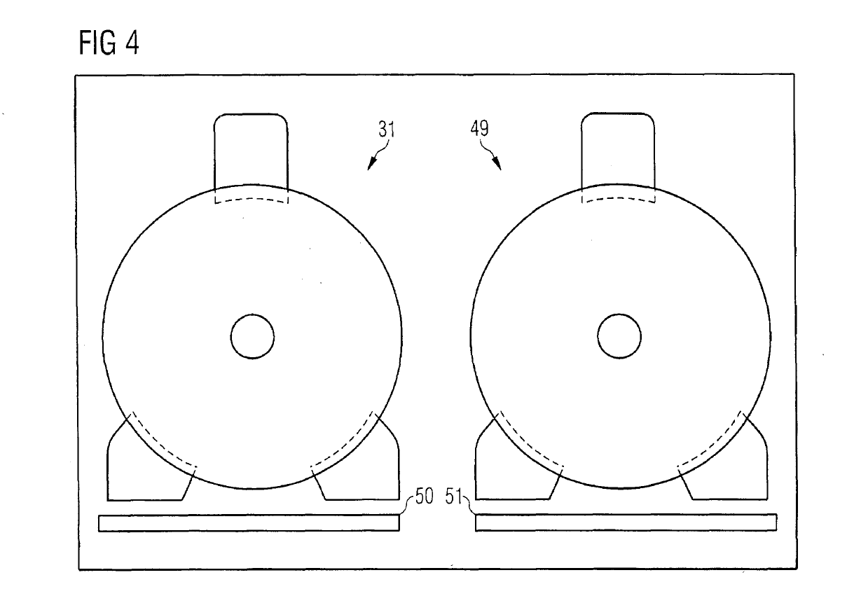

FIG. 4 shows a second DIN A4 sheet incorporating the third label applicator arrangement shown in FIG. 3 and also incorporating a fourth label applicator arrangement in accordance with the second exemplary embodiment,

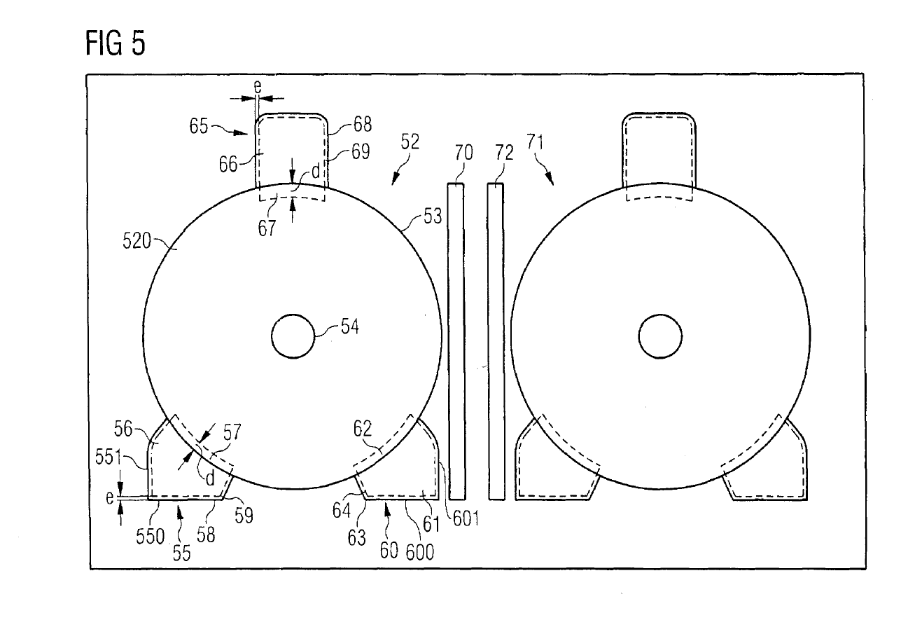

FIG. 5 shows a third DIN A4 sheet incorporating a fifth label applicator arrangement and also incorporating a sixth label applicator arrangement in accordance with a third exemplary embodiment.

FIG. 1 shows a schematic perspective illustration of an interchangeable data carrier case 1 for accommodating an interchangeable data carrier.

The interchangeable data carrier case 1 has a rectangular basic shape whose width is greater by a factor 0.15 than the length thereof. The interchangeable data carrier case 1 is divided into a seating recess 2, a first step-like filling-elevation 3, a second step-like filling-elevation 4, a retention dome 5, a hinge strip 6 and a bordering surround 7.

At the front side, the right-hand side and also the rear side of the interchangeable data carrier case 1, the bordering surround 7 is in the form of a narrow peripheral rim. The depth of the rim corresponds approximately to a twentieth of the height of the bordering surround 7. At the front and also the rear side of the bordering surround 7, there is a respective centrally disposed recess whose depth corresponds to a fortieth of the height of the bordering surround 7 and whose width corresponds to just about one third of the total width of the interchangeable data carrier case 1.

At the left-hand side of the interchangeable data carrier case 1 depicted in FIG. 1, there is a hinge strip 6 which is double the height of the bordering surround 7 and the width thereof corresponds to a tenth of the length of the interchangeable data carrier case 1.

The area bounded by the bordering surround 7 and the hinge strip 6 is rectangular and is divided into the first step-like filling-elevation 3, the second step-like filling-elevation 4, the retaining dome 5 and the circular ring-shaped seating recess 2. The first step-like filling-elevation 3, the second step-like filling-elevation 4 and the retaining dome 5 are thereby located at a height which is somewhat lower relative to the bordering surround 7. The circular ring-shaped seating recess 2 is lower relative to the first step-like filling-elevation 3, relative to the second step-like filling-elevation 4 and also relative to the retaining dome 5.

The seating recess 2 and the retaining dome 5 are designed such that an interchangeable data carrier which is not shown in FIG. 1 and may, in particular, be a CD or a DVD, can be inserted into the seating recess 2 such that it fits precisely therein. Thereby, the cylindrical retaining dome 5 engages in the circular cut-out arranged at the centre of the interchangeable data carrier in such a manner that the interchangeable data carrier will be seated firmly in the seating recess 2.

The first step-like filling-elevation 3 is terminated at the left-hand side thereof by the hinge strip 6. The intersecting edge between the upper face of the first step-like filling-elevation 3 and the right-hand side of the hinge strip 6 thereby forms a bearing edge 10.

The front and the rear part of the first step-like filling-elevation 3 are terminated by the bordering surround 7 over a distance corresponding approximately to one third of the total width of the interchangeable data carrier case 1, namely, at the respective positions whereat the recess in the bordering surround 7 begins. The intersecting edge between the upper face of the first step-like filling-elevation 3 and the front face of the bordering surround 7 thereby forms a first positioning edge 8. The intersecting edge between the upper face of the first step-like filling-elevation 3 and the rear face of the lower bordering surround 7 forms a second positioning edge 9. The right-hand part of the first step-like elevation 3 corresponds to a portion of a circular arc and is concave.

The second step-like elevation 4 is constructed in such a manner that it is terminated at the right-hand side over its entire length by the right-hand part of the bordering surround 7. The front and also the rear part of the second step-like filling-elevation 4 are respectively terminated by the bordering surround 7 over a distance of approximately one-third of the entire width of the interchangeable data carrier case 1, namely, at the respective positions whereat the recess in the bordering surround 7 begins. The left-hand part of the second step-like filling-elevation 4 corresponds to a portion of a circular arc and is concave.

FIG. 2 shows a schematic top view of a first DIN A4 sheet incorporating a first label applicator arrangement 11 and a second label applicator arrangement 12 in accordance with a first exemplary embodiment.

The first label applicator arrangement 11 is arranged in the lower half of FIG. 2 whilst the second label applicator arrangement 12 is arranged in the upper half of FIG. 2. The first label applicator arrangement 11 and the second label applicator arrangement 12 each comprise a carrier layer and also a label layer which is arranged in detachable manner on the carrier layer and is provided with a self adhesive layer on the lower face thereof. Hereby, the first label applicator arrangement 11 and the second label applicator arrangement 12 comprise a peripheral edge 13 which defines a rectangular format. The first label applicator arrangement 11 is separable from the second label arrangement 12 by a regularly discontinuous first separating impression 14. Hereby, the first separating impression 14 is formed through the carrier and also through the label layer.

The first label applicator arrangement 11 comprises a first label 110 which is to be applied to an interchangeable data carrier that is not shown in FIG. 2, and the contour thereof is defined by a first peripheral impression 15 and by a first cut-out impression 20.

Furthermore, the first label applicator arrangement 11 is divided into a first isolating impression 16, a second isolating impression 17, a first alignment impression 18, a second alignment impression 19, a first carrier layer segmenting impression and a second separating impression 22.

The first label applicator arrangement 11 and the second label applicator arrangement 12 each has a rectangular format which are of equal size.

The circular first peripheral impression 15 is arranged centrally within the first label applicator arrangement 11. The periphery of the first peripheral impression 15 corresponds approximately to two-thirds of the width of the first label applicator arrangement 11. The first peripheral impression 15 is formed merely on the label layer but not on the carrier layer.

Commencing from just below the centre of the left-hand edge 13 of the first label applicator arrangement 11, the first isolating impression 16 extends upwardly to the right at an angle of 50° to the first peripheral impression 15. The first isolating impression 16 is formed by a continuous impression through the carrier and also through the label layer.

Commencing from just below the centre of the right-hand edge of the first label applicator arrangement 11, the second isolating impression 17 extends upwardly to the left at an angle of 50° to the first peripheral impression 15. Hereby, the second isolating impression 17 is in the form of a continuous impression through the label layer and also through the carrier layer.

The first carrier layer segmenting impression 21 is provided between the first isolating impression 16 and the second isolating impression 17. It extends in parallel with the lower edge 13 and the first separating impression 14, and it divides the surface within the first peripheral impression 15 into a larger area and a smaller area. The first carrier layer segmenting impression 21 is formed exclusively on the carrier layer.

A first cut-out impression 20 is provided centrally in the first peripheral impression 15. This first cut-out impression 20 is formed exclusively through the label layer. Hereby, the diameter of the first cut-out impression 20 corresponds approximately to the circular cut-out formed within an interchangeable data carrier. Differing diameters for the cut-out impression could be envisaged.

The second separating impression 22 extends at a short distance from and in parallel with the lower edge of the first label applicator arrangement 11 and is formed in continuously interrupted manner through the carrier layer and through the label layer.

Commencing from the second separating impression 22, the first alignment impression 18 extends to the first peripheral impression 15. Hereby, the first alignment impression 18 begins at a position level with the point of the first peripheral impression 15 located furthest to the left and comprises a kink approximately in the centre thereof from which the first alignment impression 18 then runs at an angle of 30° towards the first peripheral impression 15.

Likewise, commencing from the second separating impression 22, the second alignment impression 19 extends to the first peripheral impression 15. Hereby, the second alignment impression 19 begins at a position which corresponds approximately to the part of the first peripheral impression 15 located furthest to the right. The second alignment impression 19 comprises a kink in the centre thereof from which it runs upwardly to the left at an angle of 30°.

The first alignment impression 18 and the second alignment impression 19 are formed continuously through the carrier layer and through the label layer and serve exclusively for aligning the first label applicator arrangement 11 on the interchangeable data carrier case 1.

The horizontal distance between the point where the first alignment impression 18 and the second separating impression 22 meet and also the horizontal distance between the point where the second alignment impression 19 and the second separating impression 22 meet correspond to the spacing between the first positioning edge 8 and the second positioning edge 9 of the interchangeable data carrier case shown in FIG. 1.

The length of the first alignment impression 18 and that of the second alignment impression 19 is only significant in so far as it enables alignment to be made with the data carrier case 1 with the help of an edge ensuing from the severance of the first alignment impression 18 and the second alignment impression 19.

In a further embodiment which is not illustrated here, the first alignment impression 18 and the second alignment impression 19 are formed in a straight-line and are arranged and dimensioned such that they extend at right angles away from the lower edge 13 of the first label applicator arrangement 11 over a length of approximately one eighth of the interchangeable data carrier.

The second label applicator arrangement 12 includes a second label 120 which is to be applied to an interchangeable data carrier that is not illustrated in FIG. 2, and the contour thereof is defined by a second peripheral impression 23 and by a second cut-out impression 28.

Furthermore, the second label applicator arrangement 12 comprises a third isolating impression 24, a fourth isolating impression 25, a third alignment impression 26, a fourth alignment impression 27, a second carrier layer segmenting impression 29 and a third separating impression 30.

Hereby, the shape and the arrangement of these impressions respectively correspond to the impressions in the first label applicator arrangement 11, whereby the second carrier layer segmenting impression 29 extends over the entire width of the second label applicator arrangement 12. The second label applicator arrangement 12 represents an equal-area image of the first label applicator arrangement 11 mirrored about the first separating impression 14 and comprises a second carrier layer segmenting impression 29 which is wider than the first carrier layer segmenting impression 21.

The distance between the point where the third alignment impression 26 and the third separating impression 30 meet and also the distance between the point where the fourth alignment impression 27 and the third separating impression 30 meet correspond in this embodiment to the spacing between the first positioning edge 8 and the second positioning edge 9 that is illustrated in FIG. 1.

The first exemplary embodiment will be explained hereinafter with reference to FIGS. 1 and 2. Hereby, the first label 110 is applied to an interchangeable data carrier using the first label applicator arrangement 11.

Initially, the interchangeable data carrier that is not shown in FIG. 1 is inserted into the seating recess 2 in the interchangeable data carrier case 1. Thereafter, the first label applicator arrangement 11 and the second label applicator arrangement 12 are separated from one another by severing the first separating impression 14. The first isolating impression 16 and the second isolating impression 17 are then severed.

In a next step in accordance with the invention, the first carrier layer segmenting impression 21 and the smaller part of the first peripheral impression 15 located between the first isolating impression 16 and the second isolating impression 17 are severed. The carrier layer is thereby removed from the portion of the first circular label 110 that is defined by the first carrier layer segmenting impression 21. The remaining portion of the first label applicator arrangement 11 represents wastage.

In the succeeding step of the method in accordance with the invention, the second separating impression 22 is severed. This step could also be effected earlier. The narrow strip between the second separating impression 22 and the lower edge 13 of the first label applicator arrangement 11, which ensues due to the severance of the second separating impression 22, represents wastage. Thereafter, the first alignment impression 18 and the second alignment impression 19 are severed.

The processes of severing the first isolating impression 16, the second isolating impression 17, the first carrier layer segmenting impression 21, the part of the first peripheral impression 15 arranged between the first isolating impression 16 and the second isolating impression 17, the first alignment impression 18, the second alignment impression 19 and the second separating impression 22 could also take place in a different sequence.

The first label applicator arrangement 11 is now aligned with the interchangeable data carrier case 1. For this purpose, the first label applicator arrangement 11 is rotated in such a manner that the straight edge between the first alignment impression 18 and the second alignment impression 19 will come into contact with the bearing edge 10 of the hinge strip 6. The first alignment impression 18 is thereby placed against the first positioning edge 8, whilst the second alignment impression 19 is placed against the second positioning edge 9.

That area of the first label 110 between the carrier layer segmenting impression 21 and the first peripheral impression 15 which no longer has the carrier layer thereon is stuck to the surface of the interchangeable data carrier.

The remainder of the first peripheral impression 15 is then severed whereby that part of the carrier layer of the first label application arrangement 11, which is arranged between the first carrier layer segmenting impression 21 and the remaining part of the first peripheral impression 15, will be removed. Hereby, the part of the first label 110 which has not yet been stuck onto the interchangeable data carrier is lifted and the carrier layer is peeled off in a direction towards the first alignment impression 18 and the second alignment impression 19.

Thereafter, the first cut-out impression 20 is severed and the portion of the label layer located within the first cut-out impression 20 is removed. This step could also occur prior to the detachment of the complete carrier layer from the first label 110.

Finally, commencing from the first carrier layer segmenting impression 21, the portion located between the latter and the first peripheral impression 15 that has not yet been stuck onto the data carrier is then pressed against the interchangeable data carrier and thereby adhered thereto.

Due to this manner of procedure, the first label 110 was stuck onto the interchangeable data carrier, which is not shown in FIG. 1, such that it is centralised thereon.

The application of the second label 120 to a further data carrier that is not shown in FIG. 1 occurs in an analogous manner. Hereby, the third separating impression 30, the third isolating impression 24 and the fourth isolating impression 25 are initially severed in an arbitrary sequence. Thereafter, the third alignment impression 26, the fourth alignment impression 27, the part of the second carrier layer segmenting impression 29 located between the third isolating impression 24 and the fourth isolating impression 25 and the part of the second peripheral impression 23 bounded by the carrier layer segmenting impression 29 are severed in an arbitrary sequence. The smaller portion of the carrier layer defined by the second carrier layer segmenting impression 29 and by the second peripheral impression 23 is removed from the second label 120.

The third alignment impression 26 is then aligned with the second positioning edge 9 and the fourth alignment impression 27 is aligned with the first positioning edge 8 of the interchangeable data carrier case 1. The smaller circular segment of the second label 120 defined by the second carrier layer segmenting impression 29 and by the second peripheral impression 23 is initially pressed onto the data carrier. The remaining portion of the second label 120 is then freed from its carrier layer, in that the remainder of the second peripheral impression 23 is severed by peeling off the carrier layer. Prior to or following this step, the portion of the label layer located within the second cut-out impression 28 is removed. The remaining portion of the second label 120 is then pressed onto the surface of the interchangeable data carrier.

FIG. 3 shows a schematic top view of a third label applicator arrangement 31 in accordance with a second exemplary embodiment.

The expressions “below” and “above” are used hereinafter in relation to the y-axis and the expressions “in front of” and “behind” are used in relation to the z-axis. The y-axis and the z-axis are illustrated in FIG. 3 by means of a system of coordinates.

The third label applicator arrangement 31 comprises a carrier layer and also a label layer which is detachable from the front of the carrier layer and is provided with a self-adhesive layer on the rear face thereof.

The third label applicator arrangement 31 is divided up into a third label 310, a first alignment flap 34, a second alignment flap 39 and a guide flap 44. The contour of the third label 310, which is adapted to be applied to an interchangeable data carrier, is defined by a third peripheral impression 32 and by a third cut-out impression 33. The size of the third peripheral impression 32 and the size of the third cut-out impression 33 correspond to the sizes of the first peripheral impression 15 and the first cut-out impression 20 which are depicted in FIG. 2. Hereby, the third peripheral impression 32 and the third cut-out impression 33 are only formed in the label layer but not in the carrier layer.

A first alignment flap 34 is arranged in an area of the third label 310 located below left. Hereby, the first alignment flap 34 comprises a first alignment section 34 which is formed in the carrier layer and in the label layer.

The first alignment-section 35 is arranged outside the third label 310 in the label layer and is directly seated on the third peripheral impression 32. In the carrier layer, the first alignment section 35 comprises a portion which is located behind the carrier layer and is of the same shape as the first alignment section 35 formed in the label layer, and it also comprises a first overlapping area 36 which is located behind a part of the label 310.

The first alignment section 35 comprises a first horizontal alignment edge 340 which is formed in the carrier layer and in the label layer and forms the lower face of the first alignment section 35.

Furthermore, the first alignment section 35 comprises a second alignment edge 341 which is formed in the carrier layer and in the label layer and forms the left-hand side of the first alignment section 35, this said alignment edge initially extending perpendicularly upward from the left-hand boundary of the first alignment edge 340 then making a turn to the right in a region prior to the third peripheral impression 32 and meeting the peripheral impression 32 approximately radially. In the label layer, the second alignment edge 341 is bounded by the third peripheral impression 32, whilst, in the carrier layer, the second alignment edge 341 extends for a short distance into the area enclosed by the third peripheral impression 32.

Furthermore, the first alignment section 35 comprises a right-hand edge which is formed in the carrier layer and in the label layer, said edge extending radially from the right-hand boundary of the first alignment edge 340 to the third peripheral impression 32. This right-hand edge is bounded by the third peripheral impression 32 in the label layer, whereas this right-hand edge extends for a short distance into the third peripheral impression 32 in the carrier layer.

In the label layer, a circular arc of the third peripheral impression 32 of 30° forms the upper edge of the first alignment section 35. In the carrier layer, a circular arc provided within the third peripheral impression 32 and extending approximately in parallel with the circular arc of the third peripheral impression 32 forms the upper edge of the first alignment section 35.

That portion of the first alignment section 35 on the carrier layer, which extends behind the third label 310 formed on the label layer, is referred to as the first overlapping area 36. At the lower end thereof, this first overlapping area 36 is bounded by the circular arc of the third peripheral impression 32 of 30° and is bounded by the extension of the second alignment edge 341 at its left-hand side, whilst its right-hand side is bounded by the extension of the right-hand edge of the first alignment-section 35, the upper side thereof being bounded by the circular arc provided within the third peripheral impression 32 which runs approximately in parallel with the circular arc of the third peripheral impression 32.

The first alignment edge 340, the second alignment edge 341 and the right-hand edge of the first alignment section 35 are in the form of a first label-layer alignment-section impression 37 in the label layer.

In the carrier layer, the first alignment section 35 is surrounded by a first carrier-layer alignment-section impression 38 which extends in parallel with the four edges.

A second alignment flap 39, which comprises a second alignment section 40 that is formed in the carrier layer and also in the label layer, is arranged in an area of the third label applicator arrangement 31 located at the bottom right, whereby the second alignment section 40 formed in the carrier layer includes a second overlapping area 41.

In regard to the shape and the arrangement thereof, the second alignment flap 39 corresponds to the image of the first alignment flap 34 which results from mirroring the first alignment flap 34 about a mirror axis extending vertically through the mid-point of the third label 310.

Hereby, the second alignment section 40 comprises a third horizontally extending alignment edge 390 and a fourth alignment edge 391 which forms the right-hand side thereof. The second alignment section 40 is delimited in the label layer by a second label-layer alignment-section impression 42 at its left-hand, its right-hand and its lower sides. A second carrier-layer alignment-section impression 43 is provided in the carrier layer which delimits the second alignment section 40 and the second overlapping area 41.

A guide flap 44 incorporating a guide section 45 that is formed in the carrier layer and in the label layer is provided at the centre of the upper end of the third label 310. The first guide section 45 has a third overlapping area 46 in the carrier layer.

The width and the length of the guide flap 44 hereby correspond to a quarter of the diameter of the third label 310.

The first guide section 45 is arranged outside the third label 310 in the label layer. The right-hand and left-hand edges thereof are each seated on the third peripheral impression 32, extend vertically upward and include the upper horizontal edge of the first guide section 45, whereby the respective corners between the upper edge and the left-hand and the right-hand edges are each rounded. The upper edge of the first guide section 45 is formed by the third peripheral impression 32. In the present embodiment, the left-hand, the right-hand and the upper edges of the guide flap 44 are in the form of a first label-layer guide-section impression 47 on the label layer.

The first guide section 45 is provided in the carrier layer behind the first guide-section 45 which is present in the label layer and it has the same shape thereas. In addition, the first guide section 45 in the carrier layer comprises a third overlapping area 46 which is bounded at the left-hand side by the extension of the left-hand edge of the first guide section 45, at the right-hand side by the extension of the right-hand edge of the first guide section 45 and by the third peripheral impression 32 at the upper side thereof. The lower side of the third overlapping area 46 forms a circular arc which is arranged within the third peripheral impression 32 and extends in parallel with the circular arc of the third peripheral impression 32. A first carrier-layer guide-section impression 48 is formed around the first guide section 45 including the third overlapping area 46, but only through the carrier layer and not through the label layer.

FIG. 4 shows a schematic top view of a second DIN A4 sheet incorporating the third label applicator arrangement 31 depicted in FIG. 3 and incorporating a fourth label applicator arrangement 49 in accordance with the second exemplary embodiment.

The fourth label applicator arrangement 49 hereby corresponds to the third label applicator arrangement 31 depicted in FIG. 3 in regard to the shape and the size thereof. The third label applicator arrangement 31 is arranged in the left-hand half of FIG. 4 and the fourth label applicator arrangement 49 is arranged in the right-hand half of FIG. 4.

A first inscription strip 50 is provided below the third label applicator arrangement 31 and a second inscription strip 51 is provided below the fourth label applicator arrangement 49. The inscription strips 50 and 51 are rectangular in shape and have rounded corners and they are formed merely in the label layer in FIG. 4.

The second exemplary embodiment will be explained hereinafter with reference to FIGS. 1, 3 and 4. Hereby, the third label 310 is applied to an interchangeable data carrier, which is not shown in FIG. 1, by means of the third label applicator arrangement 31.

An interchangeable data carrier is initially inserted into the seating recess 2 in the interchangeable data carrier case 1. Thereafter, the first alignment section 35, the second alignment section 40 and the first guide section 45 are released from the third label applicator arrangement 31.

This is done by severing the first label-layer alignment-section impression 37 and the portion of the first carrier-layer alignment-section impression 38 extending outside the third peripheral impression 32, the second-label layer alignment-section impression 42 and the portion of the second carrier-layer alignment-section impression 43 extending outside the third peripheral impression 32, the first label-layer guide-section impression 47 and the portion of the first carrier-layer guide-section impression 48 extending outside the third peripheral impression 32. The label layer of the first alignment section 35, of the second alignment section 40 and of the first guide section 45 are thereby released from one another.

The label layer of the third label 310 is then removed from the carrier layer but not in the overlapping areas 36, 41 and 46. In particular hereby, the guide flap 44 is gripped and the label is detached from the carrier layer in a direction from top to bottom in accordance with the illustration in FIG. 3. In the course of this detachment process, the central cut-out can remain on the carrier layer by severing the third cut-out impression 33. This can be done very easily by pressing the cut-out onto the carrier layer when detaching the label layer of the third label 310.

The third label 310 that has been detached in this manner together with the alignment flaps 34 and 39 and the guide flap 44 are now aligned with the interchangeable data carrier case 1. For this purpose, the third label applicator arrangement 31 is placed in such a manner that the alignment edges 340 and 390, which can be seen particularly easily in FIG. 3, then come into contact with the bearing edge 10 of the hinge strip 6, the second alignment edge 341 comes into contact with the first positioning edge 8 and the fourth alignment edge 391 comes into contact with the second positioning edge 9. The rear face of the label layer of the third label 310 is now adhered to the front face of the interchangeable data carrier with the exception of the overlapping areas 36, 41 and 46.

Finally, the alignment flaps 34 and 39 are removed from the third label 310 together with the guide flap 44 by pulling them off to the side. The areas of the rear face of the label 310, which correspond to the overlapping areas 36, 41 and 46 and which have been exposed in this manner, are now likewise adhered to the front face of the interchangeable data carrier by pressing the corresponding areas of the front face of the third label 310 onto the interchangeable data carrier.

In the case of the DIN A4 sheet depicted in FIG. 4, the inscription strips 50 and 51 are finally the inscription strips 52 and 53 are finally [sic] peeled off the carrier layer and stuck onto a long outer face of the interchangeable data carrier case 1.

FIG. 5 shows a schematic top view of a third DIN A4 sheet incorporating a fifth label applicator arrangement 52 and incorporating a sixth label applicator arrangement 71 in accordance with a third exemplary embodiment.

The fifth label applicator arrangement 52 serves for applying to an interchangeable data carrier a fourth label 520 whose contour is defined by a fourth peripheral impression 53 and by means of a fourth cut-out impression 54.

The fifth label applicator arrangement 52 has a third alignment flap 55 incorporating a fifth alignment edge 550, a sixth alignment edge 551, a third alignment section 56, a fourth overlapping area 57, a third label-layer alignment-section impression 58 and a third carrier-layer alignment-section impression 59.

The third alignment flap 55 corresponds essentially to the first alignment flap 34 of the third label applicator arrangement 31 but with the difference that the third carrier-layer alignment-section impression 59 does not extend exactly behind the third label-layer alignment-section impression 58 but rather, at a short distance within the third alignment section 56 in parallel with the third label-layer alignment-section impression 58.

Furthermore, the fifth label applicator arrangement 52, comprises a fourth alignment flap 60 incorporating a seventh alignment edge 600, an eighth alignment edge 601, a fourth alignment section 61, a fifth overlapping area 62, a fourth label-layer alignment-section impression 63 and a fourth carrier-layer alignment-section impression 64.

The fourth alignment flap 60 corresponds essentially to the second alignment flap 39 of the third label applicator arrangement 31 but with the difference that the fourth carrier-layer alignment-section impression 64 does not extend exactly behind the fourth label-layer alignment-section impression 63 but rather, at a short distance within the fourth alignment section 61 in parallel with the fourth label-layer alignment-section impression 63.

Furthermore, the fifth label applicator arrangement 52, has a second guide flap 65 incorporating a second guide section 66, a sixth overlapping area 67, a second label-layer guide-section impression 68 and a second carrier-layer guide-section impression 69.

The second guide flap 65 corresponds essentially to the first guide flap 44 of the third label applicator arrangement 31 but with the difference that the second carrier-layer guide-section impression 69 does not extend exactly behind the second label-layer guide-section impression 68 but rather, at a short distance within the second guide section 62 in parallel with the second label-layer guide-section impression 68.

The third carrier-layer alignment-section impression 59 extends relative to the third label-layer alignment-section impression 58 in the portion of the third alignment flap 55 that is located outside the fourth peripheral impression 53 at a distance of d=1 mm. The same spacing d=1 mm is also provided between the fourth carrier-layer alignment-section impression 64 and the fourth label-layer alignment-section impression 63, as well as between the second carrier-layer guide-section impression 69 and the second label-layer guide-section impression 68.

The circular-arc-shaped overlapping areas 57, 62 and 67 are each located at a distance of e=4 mm from the portions of the fourth peripheral impression 53 extending in parallel therewith.

A third inscription strip 70 and a fourth inscription strip 72, which extend in parallel with one another at a constant distance, are arranged between the fifth label applicator arrangement 52 and the sixth label applicator arrangement 71. The inscription strips 52 and 53 correspond to the inscription strips 50 and 51 in regard to their shape and size.

All of the impressions depicted in FIGS. 2 to 5 may be continuous or discontinuous or perforated.

The third exemplary embodiment will be explained hereinafter with reference to FIGS. 1 and 5. Hereby, the fourth label 520 is applied to an interchangeable data carrier, which is not shown in FIG. 1, by means of the fifth label applicator arrangement 52.

An interchangeable data carrier is initially inserted into the seating recess 2 in the interchangeable data carrier case 1. Thereafter, the third alignment section 56, the fourth alignment section 61 and the second guide section 66 are released from the fifth label applicator arrangement 52.

This is done by severing the third label-layer alignment-section impression 58 and the portion of the third carrier-layer alignment-section impression 59 extending outside the fourth peripheral impression 53, the fourth label-layer alignment-section impression 63 and the portion of the fourth carrier-layer alignment-section impression 64 extending outside the fourth peripheral impression 53, the second label-layer guide-section impression 68 and the portion of the second carrier-layer guide-section impression 69 extending outside the fourth peripheral impression 53. The label layer of the third alignment section 56, of the fourth alignment section 61 and of the second guide section 66 are thereby released from one another.

The label layer of the fourth label 520 is then detached from the carrier layer but not in the overlapping areas 57, 62 and 67. In particular hereby, the second guide flap 65 is gripped and the label is removed from the carrier layer in a direction extending from top to bottom. In the course of this detachment process, the central cut-out can remain on the carrier layer by severing the fourth cut-out impression 54. This can be done very easily by pressing the cut-out onto the carrier layer when detaching the label layer of the fourth label 520.

The fourth label 520 that has been detached in this manner together with the alignment flaps 55 and 60 and the second guide flap 65 are now aligned with the interchangeable data carrier case 1. For this purpose, the fourth label applicator arrangement 52 is placed in such a manner that the alignment edges 550 and 600 then come into contact with the bearing edge 10 of the hinge strip 6, the sixth alignment edge 551 comes into contact with the first positioning edge 8 and the eighth alignment edge 601 comes into contact with the second positioning edge 9.

The narrow adhesive coated edges between the third carrier-layer alignment-section impression 59 and the third label-layer alignment-section impression 58 and also between the fourth carrier-layer alignment-section impression 64 and the fourth label-layer alignment-section impression 63 can thereby be stuck onto the first step-like filling-elevation 3 in the interchangeable data carrier case, whereby the precise centring of the fourth label 520 on the interchangeable data carrier will be improved.

The rear face of the label layer of the fourth label 520 is now adhered to the front face of the interchangeable data carrier with the exception of the overlapping areas 57, 62 and 67.

Finally, the alignment flaps 55 and 60 are removed from the fourth label 520 together with the guide flap 65 by pulling them off to the side. The narrow edges between the third carrier-layer alignment-section impression 59 and the third label-layer alignment-section impression 58 and also between the fourth carrier-layer alignment-section impression 64 and the fourth label-layer alignment-section impression 63 that are adhering to the first step-like filling-elevation 3 are thereby released from the first step-like filling-elevation 3. The areas of the rear face of the fourth label 520, which correspond to the overlapping areas 57, 62 and 67 and which have been exposed in this manner, are now likewise adhered to the front face of the interchangeable data carrier by pressing the corresponding areas of the front face of the fourth label 520 onto the interchangeable data carrier.

In the case of the third DIN A4 sheet depicted in FIG. 5, the inscription strips 70 and 72 are finally peeled off the carrier layer and stuck onto a long outer face of the interchangeable data carrier case 1.

1. An arrangement for applying a label to a data carrier such that it is centralised thereon,
wherein the arrangement (11; 12) is divided into a label layer and a carrier layer, whereby the label layer is arranged on the carrier layer in detachable manner and is provided with a self-adhesive layer on the lower face thereof,
wherein the label layer comprises the following features:
a peripheral impression (15; 23) which defines the contour of the label (110; 120),
at least two label layer isolating impressions (16, 17; 24, 25) which extend respectively from an edge (13) of the label layer to the peripheral impression (15; 23),
at least one label layer alignment impression (18, 19; 26, 27) which extends from an edge (13) of the label layer at least partially towards the peripheral impression (15; 23),
wherein the carrier layer comprises the following features:
at least two carrier layer isolating impressions (16, 17; 24, 25) which each extend in parallel with a respective label layer isolating impression (16, 17; 24, 25),
at least one carrier layer alignment impression (18, 19; 26, 27) which, at least in the vicinity of an edge (13) of the carrier layer, extends in parallel with the label layer alignment impression (18, 19; 26, 27),
at least one segmenting impression (21; 29) which extends between the carrier layer isolating impressions (16, 17; 24, 25).

2. An arrangement in accordance with claim 1,
characterised in that
the label layer alignment impression (18, 19; 26, 27) extends or each of the label layer alignment impressions (18, 19; 26, 27) extend between an edge (13) of the label layer and the peripheral impression (15; 23).

3. An arrangement for applying a label to a data carrier such that it is centralised thereon,
wherein the arrangement (11; 12) is divided into a label layer and a carrier layer, whereby the label layer is arranged on the carrier layer in detachable manner and is provided with a self-adhesive layer on the lower face thereof,
wherein the label layer comprises the following features:
a peripheral impression (15; 23) which defines the contour of the label (110; 120),
at least two label layer isolating impressions (16, 17; 24, 25) which extend respectively from an edge (13) of the label layer to the peripheral impression (15; 23),
a label layer separating impression (22; 30) which extends from one edge (13) of the label layer to the opposite edge (13),
at least one label layer alignment impression (18, 19; 26, 27) which extends from the label layer separating impression (22; 30) at least partially towards the peripheral impression (15; 23),
wherein the carrier layer comprises the following features:
at least two carrier layer isolating impressions (16, 17; 24, 25) which each extend in parallel with a respective label layer isolating impression (16, 17; 24, 25),
a carrier layer separating impression (22; 30) which extends in parallel with the label layer separating impression (22; 30),
at least one carrier layer alignment impression (18, 19; 26, 27) which, at least in the vicinity of an edge of the carrier layer separating impression (22; 30), extends in parallel with the label layer alignment impression (18, 19; 26, 27),
at least one segmenting impression (21; 29) which extends between the carrier layer isolating impressions (16, 17; 24, 25).

4. An arrangement in accordance with claim 3,
characterised in that
the label layer alignment impression (18, 19; 26, 27) extends or each of the label layer alignment impressions (18, 19; 26, 27) extend between an edge (13) of the label layer separating impression (22; 29) and the peripheral impression (15; 23).

5. An arrangement in accordance with any of the preceding Claims,
characterised in that
there are provided two label layer alignment impressions (18, 19; 26, 27) and two carrier layer alignment impressions (18, 19; 26, 27) which extend in parallel therewith.

6. An arrangement in accordance with claim 5,
characterised in that
the label layer isolating impressions (16, 17; 24, 25) and the respective carrier layer isolating impressions (16, 17; 24, 25) extending in parallel therewith extend from respective opposite edges (13) of the label layer including the edge (13) of the label layer alignment impressions (18, 19; 26, 27) to the peripheral impression (15; 23).

7. An arrangement for applying a label to a data carrier such that it is centralised thereon,
wherein the arrangement (31; 52) is divided into a carrier layer and a label layer which is arranged on the carrier layer in detachable manner and is provided with a self-adhesive layer on the lower face thereof, wherein the arrangement (31; 52) comprises a label (310; 520) formed in the label layer and at least one alignment flap (34, 39; 55, 60) formed in the label layer and also in the carrier layer, which said flap is divided into a label layer alignment section (35, 40; 56, 61) bordering on the label (310; 520) and into a carrier layer alignment section (35, 40; 56, 61), wherein the label layer alignment section (35, 40; 56, 61) and the carrier layer alignment section (35, 40; 56, 61) comprise at least one common alignment edge (340, 390; 550, 600), and wherein the carrier layer alignment section (35, 40; 56, 61) comprises an overlapping area (36, 41; 57, 62) which extends below the label (310; 520).

8. An arrangement in accordance with claim 7,
characterised in that the label layer alignment section (35, 40; 56, 61) and the carrier layer alignment section (35, 40; 56, 61) comprise two common alignment edges (340-341, 390-391; 550-551, 600-601).

9. An arrangement in accordance with claim 7 or 8,
characterised in that
the label layer comprises a peripheral impression (32; 53) which defines the contour of the label (310; 520) and at least one label-layer alignment-section impression (37, 42; 58, 63) which is seated on a section of the peripheral impression (32; 53) and extends outside the peripheral impression (32; 53) and surrounds the alignment section (35, 40; 56, 61), and in that the carrier layer comprises at least one carrier-layer alignment-section impression (38, 43; 59, 64) which extends outside the peripheral impression (32; 53) in parallel with a respective label-layer alignment-section impression (37, 42; 58, 63) and surrounds a respective overlapping area (36, 41; 57, 62) within the peripheral impression (32; 53).

10. An arrangement in accordance with claim 9,
characterised in that
the carrier layer alignment section (59; 64) is located at a very small distance of, in particular, 1 mm from the label layer alignment section impression (58, 63) outside the peripheral impression (53).

11. An arrangement in accordance with any of the claims 7 to 10,
characterised in that
there is provided a guide flap (44; 65) which is divided into a label layer guide section (45; 66) bordering the label (310; 520) and a carrier layer guide section (45; 66), whereby the carrier layer guide section (45; 66) comprises an overlapping area (46; 67) which extends below the label (310; 520).

12. An arrangement in accordance with claim 11,
characterised in that
the guide flap (44; 65) is arranged at the side of the peripheral impression (32; 53) remote from the alignment flap or the alignment flaps (34, 39; 55, 60).

13. An arrangement in accordance with claim 11 or 12,
characterised in that
the label layer comprises a label-layer guide-section impression (47; 68) which is seated on a section of the peripheral impression (32; 53), extends outside the peripheral impression (32; 53) and surrounds the guide section (45; 66), and in that the carrier layer comprises a carrier-layer guide-section impression (48; 69) which extends outside the peripheral impression (32; 53) in parallel with the label-layer guide-section impression (47; 68) and surrounds the overlapping area (46; 67) within the peripheral impression (32; 53).

14. An arrangement in accordance with any of the claims 9, 10 or 13,
characterised in that
the overlapping area or the overlapping areas (36, 41, 46; 57, 62, 67) is or are in the shape of a circular arc and has or have a very small width of, in particular, 4 mm.

15. An arrangement in accordance with any of the claims 7 to 14,
characterised in that
two alignment flaps (34, 39; 55, 60) are provided.

16. An arrangement in accordance with any of the preceding Claims,
characterised in that
the peripheral impression (15, 23; 32; 53) has a circular shape.

17. An arrangement in accordance with any of the preceding Claims,
characterised in that
a cut-out impression (20; 28; 53; 54) defining the central cut-out in the label (110; 120; 310; 530) is provided on the label layer.

18. A self-adhesive printing paper, which is divided into a label layer that is provided with a self-adhesive layer on the lower face thereof and a carrier layer upon which the label layer is arranged in detachable manner, wherein areas are provided which comprise arrangements (11; 12; 31; 53) in accordance with any of the preceding Claims.

19. A method of applying a label to a data carrier inserted into a data carrier case such that it is centralised thereon using an arrangement in accordance with any of the claims 1 to 6, 16 or 17, wherein the data carrier case (1) comprises a seating recess (2) for accommodating a data carrier, at least one positioning edge (8; 9) and a bearing edge (10),
wherein the method comprises the following steps:
a) inserting a data carrier into the seating recess (2),
b) severing the label layer isolating impressions (16, 17; 24, 25) and the carrier layer isolating impressions (16, 17; 24, 25),
c) severing the segmenting impression (31; 29) and the part of the peripheral impression (15; 23) arranged between the label layer isolating impressions (16, 17; 24, 25) and peeling off the portion of the carrier layer arranged between the segmenting impression (21; 29) and the peripheral impression (15; 23),
d) severing a label layer alignment impression (18; 27) and the parallel carrier layer alignment impression (18; 27),
e) aligning the label layer alignment impression (18; 27) severed in step d) with a positioning edge (8) of the data carrier case (1), whereby the straight edge bordering the label layer alignment impression (18; 27) is placed against a bearing edge (10) of the data carrier case (1), and whereby the lower face of the label layer is directed towards the upper face of the data carrier,
f) adhering the lower face of the part of the label layer having no carrier layer thereon and arranged between the segmenting impression (21; 29) and the peripheral impression (15; 23) to the upper face of the data carrier,
g) severing the remaining part of the peripheral impression (15; 23) and peeling off the remaining portion of the carrier layer arranged between the segmenting impression (21; 29) and the peripheral impression (15; 23),
h) adhering the lower face of the portion of the label layer that has not yet been stuck onto the upper face of the data carrier and is arranged between the segmenting impression (21; 29) and the peripheral impression (50; 23) onto the upper face of the data carrier.

20. A method in accordance with claim 19,
characterised in that
in the event that there are provided two label layer alignment impressions (18, 19) and two parallel extending carrier layer alignment impressions (18, 19),
then, instead of the steps d) and e), the following steps are carried out:
d′) severing the two label layer alignment impressions (18, 19) and the two carrier layer alignment impressions (18, 19),
e′) aligning the first label layer alignment impression (18; 27) with the first positioning edge (8) and the second label layer alignment impression (19; 26) with the second positioning edge (9) of the data carrier case (1), whereby the straight edge included by the two label layer alignment impressions (18, 19; 26, 27) is placed against a bearing edge (10) of the data carrier case (1) and whereby the lower face of the label layer is directed towards the upper face of the data carrier.

21. A method in accordance with claim 19 or 20,
characterised in that
in the event that there is provided one label layer separating impression (22; 30) and one carrier layer separating impression (22; 30),
then, the following step is carried out after step a):
a′) severing the label layer separating impression (22; 30) and the carrier layer separating impression (22; 30).

22. A method of applying a label to a data carrier inserted into a data carrier case such that it is centralised thereon using an arrangement in accordance with any of the claims 7 to 17, wherein the data carrier case (1) comprises a seating recess (2) for accommodating a data carrier, at least one positioning edge (8; 9) and a bearing edge (10),
wherein the method comprises the following steps:
a) inserting a data carrier into the seating recess (2),
b) releasing the label layer alignment section or alignment sections (35, 40; 56, 61) from the label layer and the carrier layer alignment section or alignment sections (35, 40; 56, 61) from the carrier layer with the exception of the overlapping area or areas (36, 41; 57, 62),
c) peeling off the label (310, 520) from the carrier layer with the exception of the overlapping area or areas (36, 41; 57, 62),
d) aligning the alignment edge or edges (340-341, 390-391; 550-551, 600-601) with at least one positioning edge (8, 9) and/or a bearing edge (10), whereby the lower face of the label layer is directed towards the upper face of the data carrier,
e) adhering the lower face of the label (310; 520) to the upper face of the data carrier,
f) laterally peeling off the alignment flap (34; 55) or the alignment flaps (34, 39; 55, 60),
g) adhering the overlapping area (36; 57) or the overlapping areas (36, 41; 57, 62) of the label layer to the upper face of the data carrier.

23. A method of applying a label to a data carrier inserted into a data carrier case such that it is centralised thereon using an arrangement in accordance with any of the claims 9 to 17, wherein the data carrier case (1) comprises a seating recess (2) for accommodating a data carrier, at least one positioning edge (8; 9) and a bearing edge (10),
wherein the method comprises the following steps:
a) inserting a data carrier into the seating recess (2),
b) severing the label-layer alignment-section impression (37; 58) and the portion of the carrier-layer alignment-section impression (38; 59) extending in parallel therewith, or severing the label-layer alignment-section impressions (37, 42; 58, 63) and the portions of the carrier-layer alignment-section impressions (38, 43; 59, 64) extending in parallel therewith,
c) severing the portion of the peripheral impression (32) bordering the alignment flap (34; 55), or severing the portions of the peripheral impression (32; 53) located between the alignment flaps (34, 39; 55, 60),
d) peeling off the portion of the label layer arranged within the peripheral impression (32; 53) from the carrier layer with the exception of the overlapping area (36; 57) or the overlapping areas (36, 41; 57, 62),
e) aligning the alignment edges (340-341, 390-391; 550-551, 600-601) with at least one positioning edge (8, 9) and/or a bearing edge (10), whereby the lower face of the label layer is directed towards the upper face of the data carrier,
f) adhering the lower face of the label (310; 520) to the upper face of the data carrier,
g) laterally peeling off the alignment flap (34; 55) or the alignment flaps (34, 39; 55, 60),
g) adhering the overlapping area (36; 57) or the overlapping areas (36, 41; 57, 62) of the label layer to the upper face of the data carrier.

24. A method of applying a label to a data carrier inserted into a data carrier case such that it is centralised thereon using an arrangement in accordance with any of the claims 11 to 17, wherein the data carrier case (1) comprises a seating recess (2) for accommodating a data carrier, at least one positioning edge (8; 9) and a bearing edge (10),
wherein the method comprises the following steps:
a) inserting a data carrier into the seating recess (2),
b) releasing the label layer alignment section (35; 56) or the label layer alignment sections (35, 40; 56, 61) from the label layer and the carrier layer alignment section (35; 56) or the carrier layer alignment sections (35, 40; 56, 61) from the carrier layer with the exception of the overlapping area (36; 57) or the overlapping areas (36, 41; 57, 62),
c) releasing the label layer guide section (45; 66) from the label layer and the carrier layer guide section (45; 66) from the carrier layer with the exception of the overlapping area (46; 67)
d) peeling off the label (310, 520) from the carrier layer with the exception of the overlapping areas (36, 41, 46; 57, 62, 67), commencing, in particular, from the guide section (45; 66) in a direction towards the alignment section (35; 56) or the alignment sections (35, 40; 56, 61)
e) aligning the alignment edges (340-341, 390-391; 550-551; 600-601) with at least one positioning edge (8, 9) and/or a bearing edge (10), whereby the lower face of the label layer is directed towards the upper face of the data carrier,
f) adhering the lower face of the label (310; 520) to the upper face of the data carrier,
g) laterally peeling off the alignment flap (34; 55) or the alignment flaps (34, 39; 55, 60) and the guide flap (44; 65),
h) adhering the overlapping areas (36, 41, 46; 57, 62, 67) of the label layer to the upper face of the data carrier.

25. A method of applying a label to a data carrier inserted into a data carrier case such that it is centralised thereon using an arrangement in accordance with any of the claims 13 to 17, wherein the data carrier case (1) comprises a seating recess (2) for accommodating a data carrier, at least one positioning edge (8; 9) and a bearing edge (10),
wherein the method comprises the following steps:
a) inserting a data carrier into the seating recess (2),
b) severing the label-layer alignment-section impression (37; 58) and the portion of the carrier-layer alignment-section impression (38; 59) extending in parallel therewith, or severing the label-layer alignment-section impressions (37, 42; 58, 63) and the portions of the carrier-layer alignment-section impressions (38, 43; 59, 64) extending in parallel therewith,
c) severing the label-layer guide-section impression (47; 68) and the carrier-layer guide-section impression (48; 69) extending in parallel therewith,
d) severing the portions of the peripheral impression (32; 53) located between the alignment flap (34; 55) and the guide flap (44; 65), or severing the portions of the peripheral impression (32; 53) located between the alignment flaps (34, 39; 55, 60) and between the alignment flaps (34, 39; 55, 60) [sic] and the guide flap (44; 65),
e) peeling off the portion of the label layer arranged within the peripheral impression (32; 53) from the carrier layer with the exception of the overlapping areas (36, 41, 46; 57, 62, 67),
f) aligning the alignment edge or edges (340-341, 390-391; 550-551; 600-601) with at least one positioning edge (8, 9) and/or a bearing edge (10), whereby the lower face of the label layer is directed towards the upper face of the data carrier,
g) adhering the lower face of the label (310; 520) to the upper face of the data carrier,
h) laterally peeling off the alignment flap (34; 55) or the alignment flaps (34, 39; 55, 60) and the guide flap (44; 65),
i) adhering the overlapping areas (36, 41, 46; 57, 62, 67) of the label layer to the upper face of the data carrier.

26. A method in accordance with any of the claims 19 to 25,
characterised in that
in the event that a cut-out impression (20, 28; 33; 54) is provided on the label layer,
then, the following additional step is carried out:
severing the cut-out impression (20, 28; 33; 54) and removing the portion of the label layer located within the cut-out impression (20, 28; 33; 54).
